(19) United States
(12) Patent Application Publication
(10) Pub. No.: US 2007/0075066 A1
(43) Pub. Date: Apr. 5, 2007

(54) Fixing device and image forming apparatus using the same

(75) Inventor: Noriyuki Miyoshi, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/352,314

(22) Filed: Feb. 13, 2006

(30) Foreign Application Priority Data
Sep. 16, 2005 (JP) P2005-270766

(51) Int. Cl. H05B 3/00; H05B 1/00; H05B 11/00

(52) U.S. Cl. 219/216

(57) ABSTRACT

The fixing device fixes a toner image on a recording material. The fixing device has a fixing member having a heat source; a temperature sensor which senses a surface temperature of the fixing member; an abnormality determining section which obtains temperature-rising time information in a predetermined temperature range that enables water in the recording material to evaporate based on information from the temperature sensor, to determine whether or not an abnormality exists in the fixing member based on a result of the measurement; and a heat controlling section which supplies power to the heat source, and lowers a supplying amount of the power in operation when the abnormality determining section determines an abnormality exists.

### CROSS-REFERENCE TO RELATED APPLICATIONS

This application is based upon and claims the benefit of priority from the prior Japanese Patent Applications No. 2005-270766, filed on Sep. 16, 2005, the entire contents of which are incorporated herein by reference.

### BACKGROUND OF THE INVENTION

1. Field of the Invention

The present invention relates to an image forming apparatus such as a copy machine or a printer. More specifically, the present invention relates to improvement of a fixing device with high safety against troubles caused by jamming of recording materials and an image forming apparatus using the fixing device.

2. Description of the Related Art

As a fixing device for fixing toner of a recording material in an image forming apparatus employing an electrophotography method, for example, there has been conventionally known a device using a heating roll with simple conditions on heat and pressure in a fixing process. In this device, the heating roll is disposed on at least a toner image side on the recording material, and the toner is fixed when the recording material is nipped and conveyed between the heating roll and a pressure roll.

However, in such a fixing device, if a pressure applied to the recording material against the heating roll is increased due to any causes when the recording material is discharged from the fixing device, the recording material is wound around the heating roll. Typically, since such winding of the recording material is eliminated when a jam cleared, it causes little trouble.

However, in a recent high speed image forming apparatus, for example when a jam occurs as the recording material is wound around the heating roll in the fixing process, even though the jam is cleared, not all the recording materials to be removed may be removed since a user can not find subsequent recording materials remaining in the apparatus. In this case, the apparatus may be started though the subsequent recording materials are remaining without being removed, and the recording materials are newly wound around the heating roll after the clearance of jam. In addition, in the case of winding jam, since it is difficult to find the wound recording material, the apparatus may often be restarted without removing the wound recording material.

In the mean time, at a surface side of the heating roll of the fixing device is typically provided a temperature sensor for controlling heating of the heating roll, and the supply of power to the heating roll is controlled by the temperature sensor.

In this case, when the heating roll begins to heat by warming up after occurrence of the jam, the power continues to be supplied to the heating roll and the temperature of the heating roll continues to increase until the temperature of the heating roll reaches a reference value set by the temperature sensor under control by the temperature sensor.

At this time, if the recording material is wound around the heating roll, temperature sensed by the temperature sensor is lower than an actual temperature due to the wound recording material. Accordingly, since a correct heating control of the heating roll is not achieved, smoke may be emitted due to abnormal increase of the temperature of the heating roll, which may result in outbreak of a fire.

### SUMMARY OF THE INVENTION

The present invention provides a fixing device that addresses improvement in safety to jamming of a recording material in the fixing device, and provides an image forming apparatus using the fixing device.

As a result of investigations made by the inventors on temperature increase when a recording material winds around a heating roll of a fixing device, it has been found that upon heating a recording medium, water contained in the recording medium evaporates before reaching the fixing temperature, and thus there is such a region that the temperature is not increased substantially linearly, but the temperature increase is largely deferred. The fixing device and the image forming apparatus according to the invention have been completed based on the findings.

According to an aspect of the present invention, a fixing device includes a fixing member having a heat source, a sensor which senses a surface temperature of the fixing member, an abnormality determining section which obtains at least one of temperature-rising time information in a predetermined temperature range, temperature-rising time information in a temperature range lower than the predetermined temperature range, and temperature-rising time information in a temperature range higher than the predetermined temperature range, based on a result of sensing by the sensor, to determine whether or not an abnormality exists in the fixing member based on the obtained information, and a heat controlling section which controls a power supply to the heat source, and lowers an amount of the power supply in operation when the abnormality determining section determines that an abnormality exists.

According to another aspect of the present invention, a fixing device includes a fixing member having a heat source, a sensor which senses a surface temperature of the fixing member, an abnormality determining section which obtains temperature-rising time information in a predetermined temperature range to determine whether or not an abnormality exists in the fixing member based on the obtained information, and a heat controlling section which controls a power supply to the heat source, and lowers an amount of the power supply in operation when the abnormality determining section determines that an abnormality exists.

According to still another aspect of the present invention, an image forming apparatus includes an image forming section which forms a toner image on a recording medium and a fixing device which fixes the toner image on the recording medium. The fixing device includes a fixing member having a heat source, a sensor which senses a surface temperature of the fixing member, an abnormality determining section which obtains at least one of temperature-rising time information in a predetermined temperature range, temperature-rising time information in a temperature range lower than the predetermined temperature range, and temperature-rising time information in a temperature range higher than the predetermined temperature range, based on a result of sensing by the sensor, to determine whether or not an abnormality exists in the fixing member based on the obtained information, and a heat controlling section which controls a power supply to the heat source, and lowers an amount of the power supply in operation when the abnormality determining section determines that an abnormality exists.

### BRIEF DESCRIPTION OF THE DRAWINGS

FIG. 1 is an illustrative view showing an overview of a fixing device according to the invention;

FIG. 2 is a graph showing temperature increase upon fixing;

FIG. 3 is an illustrative view showing an exemplary embodiment of an image forming apparatus;

FIG. 4 is an illustrative view showing a fixing device of the embodiment;

FIG. 5 is a block diagram showing a controlling device of the embodiment;

FIG. 6 is a flow chart showing a part of the temperature controlling process;

FIG. 7A is a graph showing temperature increase in the embodiment in the normal state, and FIG. 7B is a graph showing temperature increase in the embodiment with paper winding;

FIG. 8 is a flow chart showing the remaining part of the temperature controlling process; and

FIG. 9 is an illustrative view showing comparisons of timers in the embodiment.

### DETAILED DESCRIPTION OF INVENTION

An outline and an exemplary embodiment of the invention will be described in detail below with reference to the drawings.

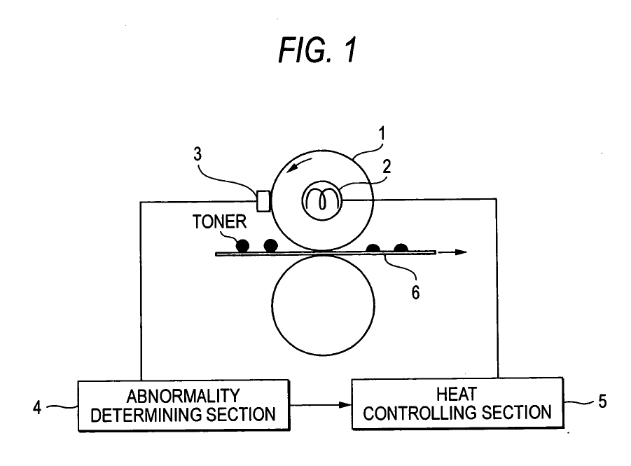

An outline of the fixing device for fixing a toner image on a recording material is described with reference to FIG. 1. The fixing device includes a fixing member 1 having a heat source 2; a temperature sensor 3 which senses a surface temperature of the fixing member 1; an abnormality determining section 4 which obtains temperature-rising time information in a predetermined temperature range that enables water in the recording material 6 to evaporate based on information from the temperature sensor 3, to determine whether or not an abnormality exists in the fixing member 1 based on a result of the measurement; and a heat controlling section 5 which supplies power to the heat source 2, and lowers a supplying amount of the power in operation when the abnormality determining section 4 determines that an abnormality exists.

In the aforementioned configuration, the fixing member 1 is not limited in shape and may be in a roll form or a belt form, and the heat source 2 is not limited in number. Furthermore, the heat source 2 may be equipped inside or outside the fixing member 1. A representative embodiment of the fixing member is constituted by a heating roll having a heat source 2 inside and a pressure roll disposed to face the heating roll.

The temperature sensor 3 is not limited in number, and plural sensors may be provided as far as the surface temperature of the fixing member 1 can be sensed. Examples thereof include a thermosensitive device, such as a thermistor, or an optical device, such as an infrared sensor, is disposed in contact with the fixing member 1 or on the fixing sensor 1 with a certain distance. In the case where the temperature sensor 3 is disposed in contact with the fixing member 1, it may be disposed in an area outside the recording material passing.

The abnormality determining section 4 may obtain temperature-rising time information in a predetermined temperature range that enables water in the recording material 6 to evaporate based on information from the temperature sensor 3, to determine whether or not an abnormality exists in the fixing member 1, i.e., winding of the recording medium thereon, based on a result of the measurement, and for example, the temperature-rising time information thus obtained is compared to the reference temperature information having been defined in advance. The term “temperature-rising time information” herein includes not only the time itself but also information indirectly connected to the time.

The abnormality detecting section 4 preferably determines abnormality in the recording material winding from temperature-rising time information in at least a part of temperature range of 80° C. to 120° C. inclusive, for clarifying the temperature range that enables water to evaporate from the recording material 6. The evaporation of water from the recording material 6 occurs conspicuously in the temperature range of 80° C. to 120° C. while it depends on the environment (such as temperature, humidity and pressure). Furthermore, the abnormality determining section 4 preferably determines abnormality from temperature-rising time information in the temperature range of 80° C. to 100° C.

The heat controlling section 5 supplies power to the heat source 2 of the fixing member 1, and in the case where the abnormality determining section 4 determines an abnormality of the recording material winding exists, it lowers the supplying amount of the power in operation. In particular, the heat controlling section 5 preferably terminates power to the heat source 2 from the standpoint of safety. It is also preferred that the abnormality thus determined is sent from the heat controlling section 5 to a UI (user interface) screen or the like to indicate thereon, whereby the user is notified with occurrence of abnormality.

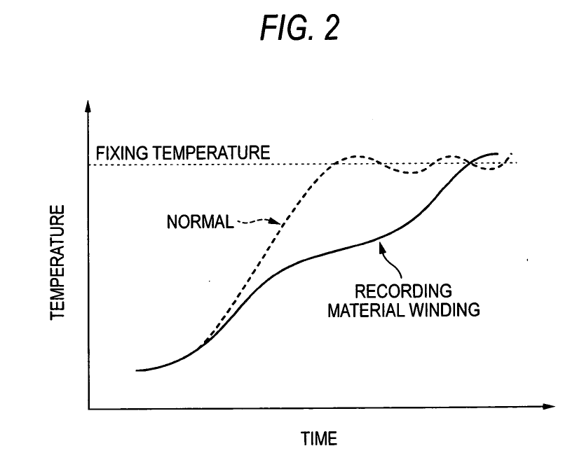

The invention positively uses such a phenomenon that upon winding the recording material 6 around the fixing member 1, the temperature-rising time is prolonged by evaporation of water in the recording material 6, and thus abnormality in winding of the recording material 6 can be sufficiently detected even though fluctuations occur in parts constituting the apparatus. As shown in FIG. 2, in the case where the recording material 6 does not wind around the fixing member 1 in the normal state, the temperature of the fixing member 1 is increased with the heat source 2 drawing an S-shaped curve until reaching the fixing temperature. In this case, the temperature-rising rate is relatively larger in the midstream temperature range, in which influence of evaporation of water in the recording medium becomes remarkable, and therefore, abnormality in the recording material 6 winding can be readily determined by noting the temperature-rising time information in the midstream temperature range.

In the fixing device, furthermore, the abnormality determining section 4 preferably designates temperature-rising time information in a temperature range of 80° C. or less or a temperature range of 120° C. or more as a reference time information, and determines abnormality in the recording material winding when temperature-rising time information in the temperature range of 80° C. to 120° C. is slower (longer in the case of time) than the reference time information. According to the configuration, the temperature-rising time information can be directly compared under the same conditions including the installation environment of the apparatus and the fluctuation of the parts, whereby the influence of the conditions including the installation environment of the apparatus and the fluctuation of the parts may not be considered if any. Accordingly, the abnormality in the recording material winding around the fixing member 1 can be accurately detected. The temperatures 80° C. and 120° C. literally belong to the temperature ranges adjacent to each other, but it is noted that these temperatures merely mean boundary points.

Furthermore, the abnormality determining section 4 preferably designates the temperature-rising time information in a temperature range of 80° C. or less or a temperature range of 120° C. or more by switching as the reference time information. In this case, the proper temperature range can be selected, and for example, in the case where the temperature decrease upon occurring jam in the fixing device 1 is small, the temperature range of 120° C. or more can be properly selected.

The temperature-rising time information obtained based on information from the temperature sensor 3 is obtained with the same temperature-rising width or parameters corresponding to the same temperature-rising width in the measurements of the temperature-rising time information in each temperature range.

In an embodiment having plural temperature sensors 3 in the fixing device, it is preferred that the abnormality determining section 4 obtains the temperature-rising time information based on all the temperature sensors 3, and the heat controlling section 5 lowers the supplying amount of the power in operation when it is determined that an abnormality of the recording material winding based on a measurement result of at least one of the temperature sensors 3. In this configuration, the fail-safe system is further improved to increase the safety.

The invention provides not only the aforementioned fixing device but also an image forming apparatus, and in the later case, the image forming apparatus may contain an image forming section forming a toner image on the recording material 6 and the aforementioned fixing device.

According to the fixing device, the fixing device for fixing a toner image on a recording material includes a fixing member having a heat source, a temperature sensor, an abnormality determining section which obtains temperature-rising time information in a predetermined temperature range that enables water in the recording material to evaporate based on information from the temperature sensor, to determine whether or not an abnormality of the fixing member winding exists in the fixing member based on a result of the measurement, and a heat controlling section which lowers a supplying amount of power to the heat source in operation when the abnormality determining section determines an abnormality of winding exists in the fixing member. Therefore, even in the case where power is supplied to the heat source in a state where the recording material winds around the fixing member, abnormality of the recording medium winding can be detected, whereby the power supply to the heat source can be lowered to provide a fixing device excellent in safety.

Furthermore, an image forming apparatus excellent in safety can be provided by using the fixing device.

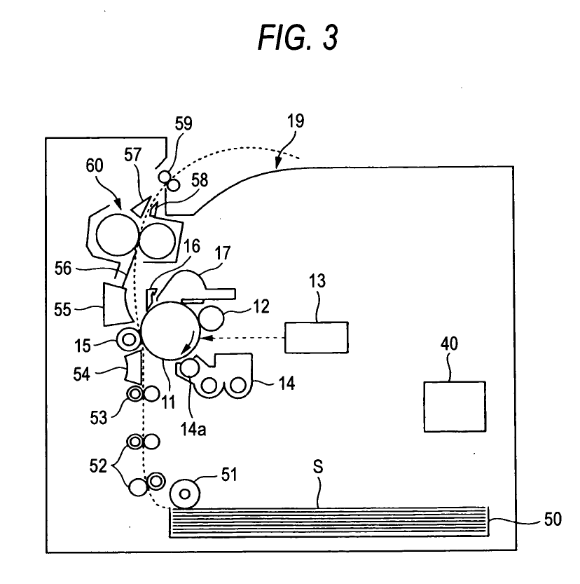

FIG. 3 is an illustrative view showing an exemplary embodiment of the image forming apparatus. In FIG. 3, the image forming apparatus of the embodiment has a photoreceptor drum 11 as an image carrying member carrying an electrostatic latent image disposed at a substantially center part, a paper feeding cassette 50 containing paper S as a recording material disposed at a lower part, and a fixing device 60 for fixing a toner image formed on the paper S with the photoreceptor drum 11.

The image forming apparatus having the configuration has a considerably short conveying path for conveying the paper S, and the most part of the conveying path for the paper S can be exposed to the exterior by opening only one side cover of the image forming apparatus. Therefore, the period of time required from paper feed to output can be shortened, and simultaneously, the conveying property of the paper S is improved to provide convenience in removing the paper S when jamming occurs.

On the circumference of the photoreceptor drum 11, such electrophotographic devices are disposed as a charging device 12, such as a charging roll, for charging the photoreceptor drum 11, an exposing device 13, such as a laser exposing device, for writing an electrostatic latent image onto the charged photoreceptor drum 11, a developing device 14 for visualizing the electrostatic latent image written on the photoreceptor drum with a toner, a transferring device 15, such as a transferring roll, for transferring the toner image formed on the photoreceptor drum through development onto the paper S, and a drum cleaner 17 for removing the toner remaining on the photoreceptor drum 11.

The paper conveying system in the image forming apparatus of the embodiment has a paper feeding cassette 50 containing the paper S capable of being fed, a pickup roll 51 for feeding the paper S contained in the paper feeding cassette 50 at a predetermined timing, conveying rolls 52 for conveying the paper S thus fed with the pickup roll 51, a registration roll 53 for alignment of the paper S thus conveyed and then forwarding the paper S toward the transferring device 15 at a predetermined timing, an inlet chute 54 for guiding the paper S thus forwarded with the registration roll 53 to a transferring nip part (i.e., the part where the photoreceptor drum 11 and the transferring device 15 face each other), a conveying guide 55 for conveying the paper S having a toner image to the fixing device 60 after transferring the toner image onto the paper S with the transferring device 15, a fixing inlet guide 56 disposed upstream of the fixing device 60 for guiding the guiding the paper S having the toner image transferred thereon to the fixing device 60, and paper exit guides 57 and 58 for guiding the paper S delivered from the fixing device 60 to an exit roll 59 for outputting the paper S to an exit tray 19 disposed on the surface of the case of the image forming apparatus. In the figure, numeral 16 denotes a releasing blade for preventing the paper S having the toner image transferred thereon from being wound around the photoreceptor drum 11.

The image forming apparatus of the embodiment further has a controlling device 40 for controlling the devices and parts inside the apparatus.

The fixing device 60 of the embodiment will be described.

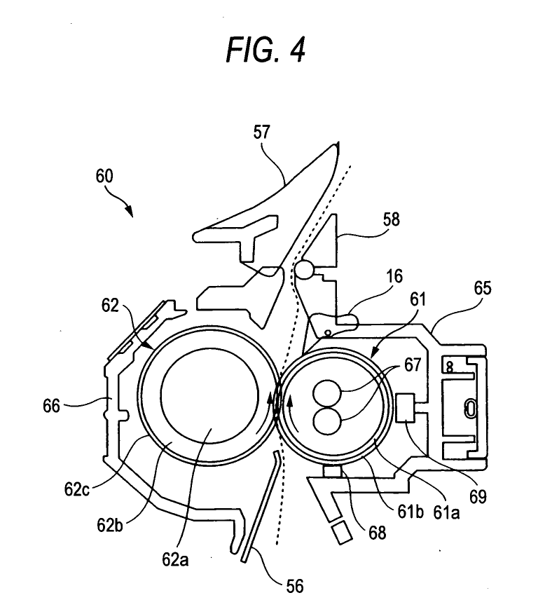

As shown in FIG. 4, the fixing device 60 of the embodiment has a heating-side case 65 for rotatably supporting a heating roll 61 and a pressuring-side case 66 supporting a pressure roll 62 rotatably, which are connected to each other to constitute a unit. The fixing device 60 is installed inside the image forming apparatus in such a manner that the straight line connecting the center of the heating roll 61 and the center of the pressure roll 62 is in a substantially horizontal direction. The pressure roll 62 is pressed with an elastic body, such as a spring, which is not shown in the figure, toward the heating roll 61, so as to form a predetermined fixing nip between them.

The heating roll 61 is constituted by a cylindrical rigid core 61a formed of a metal having good thermal conductivity, such as aluminum, having coated thereon a heat-resistant releasing layer 61b, such as a silicone resin or a fluorine resin, having good release characteristics to a toner. The releasing layer 61b may be a fluorine resin from the standpoint of release characteristics to a toner and wear resistance, and specific examples thereof include a tetrafluoroethylene-perfluoroalkyl vinyl ether copolymer (PFA), polytetrafluoroethylene (PTFE) and a tetrafluoroethylene-hexafluoropropylene copolymer (FEP).

The heating roll 61 has, for example, a halogen heater 67 inside for heating the heating roll 61 from the interior. A temperature sensor 68 is disposed on the surface of the heating roll 61 in contact thereto in an area outside the area where the paper is conveyed. A thermostat 69 is disposed on the heating roll 61 with a certain distance upstream of the moving direction of the heating roll 61.

The pressure roll 62 is constituted, for example, by a cylindrical metallic shaft 62a, a heat-resistant elastic layer 62b provided around the metallic shaft 62a, and a releasing layer 62c covering the surface of the heat-resistant elastic layer 62b. The metallic shaft 62a is formed, for example, of iron or aluminum, which may be a hollow shaft. The heat-resistant elastic layer 62b is constituted by a material excellent in heat resistance and mechanical strength, such as silicone rubber sponge or silicone rubber. The releasing layer 62c may be the similar material as the releasing layer 61b of the heating roll 61.

The heating roll 61 and the pressure roll 62 are constituted as above, and the heating roll 61 is pressed onto the pressure roll 62 to form a substantially constant fixing nip.

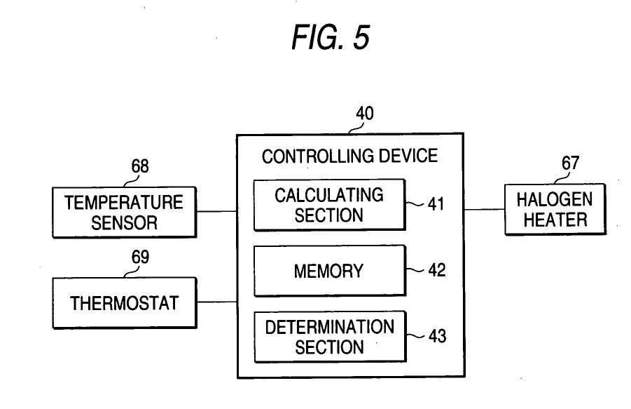

In the embodiment, the heating operation of the fixing device 60 is controlled with the controlling device 40 in the manner shown in FIG. 5. Input information to the controlling device 40 includes temperature information from the temperature sensor 68 and on/off information from the thermostat 69 (for example, it is turned off on exceeding a preset temperature), and the controlling device 40 controls the on/off state of the halogen heater 67 of the heating roll 61 based on a result obtained by processing in the controlling section 40. The controlling device 40 itself contains a calculating section 41 for calculating a temperature-rising time per temperature increase based on the temperature data from the temperature sensor 68, a memory 42 for storing the temperature-rising time calculated by the calculating section 41, and a determination section 43 for determining the length of the temperature-rising time calculated by the calculating section 41 and stored in the memory 42 by comparing it with a reference temperature-rising time stored in the memory 42.

The basic image forming process executed in the image forming apparatus of the embodiment will be described.

As shown in FIG. 3, an electrostatic latent image is formed on the photoreceptor drum 11 having been charged with the charging device 12, with the exposing device 13 controlled by output of an image processing apparatus, which is not shown in the figure, based on a signal of image data. The electrostatic latent image on the photoreceptor drum 11 is visualized with a developing roll 14a of the developing device 14 to form a toner image.

The paper S fed from the paper feeding cassette 50 with the pickup roll 51 is guided to the registration roll 53 through the conveying rolls 52 for alignment, and then delivered to the position of the transferring device 15 through the inlet chute 54.

In the transferring device 15, the toner image on the photoreceptor drum 11 is transferred to the paper S thus delivered, and the paper S having the toner image transferred thereon is conveyed to the fixing device 60 through the conveying guide 55 and the fixing inlet guide 56. The paper S having the toner image fixed thereon in the fixing device 60 is delivered to the exit tray 19 through the paper exit guides 57 and 58 and the exit roll 59.

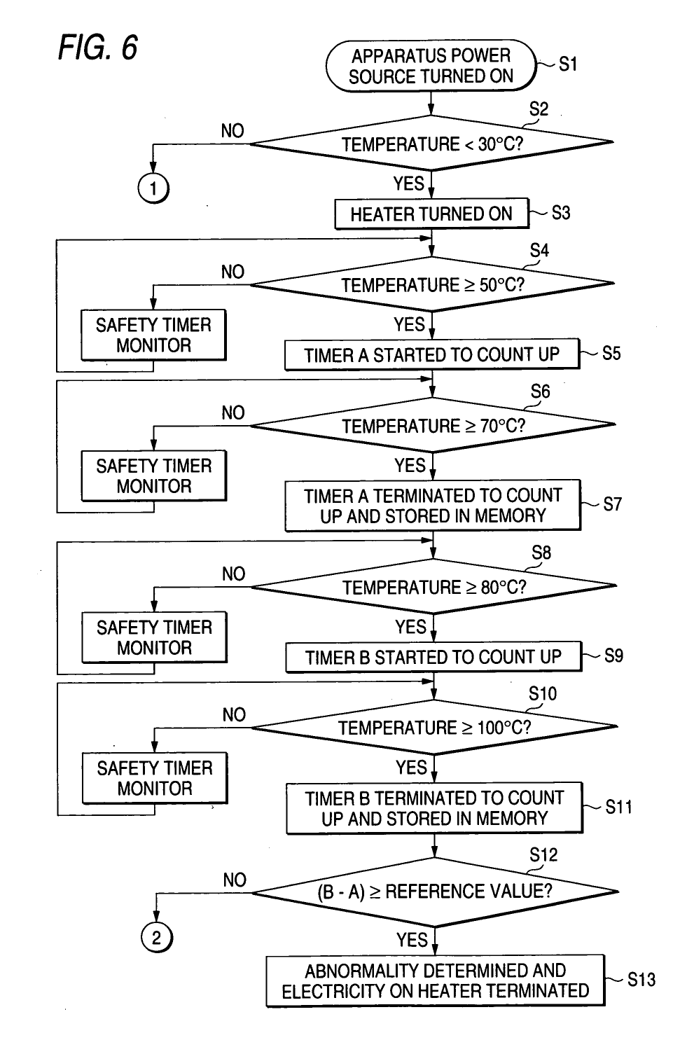

The temperature controlling method of the fixing device 60 of the embodiment in the image formation process will be described. FIG. 6 is a flow chart showing a part of the temperature controlling process, and the controlling operation is carried out in the controlling device 40 (see FIG. 5). The following description will be made with reference to FIGS. 4 and 5 in addition to FIG. 6.

In the case, for example, where the apparatus power source is once turned off upon paper jam, and then again turned on (power source ON) after resolving the paper jam, it is determined as to whether or not the surface temperature of the heating roll 61 sensed with the temperature sensor 68 in the fixing device 60 is less than 30° C. In the case where it is less than 30° C., the halogen heater (heater) 67 of the heating roll 61 is turned on to start increase of the temperature of the heating roll 61 (steps S1 to S3).

When the temperature sensed with the temperature sensor 68 reaches 50° C., a timer A in the calculating section 41 of the controlling device 40 is started to count up. A safety timer contained in the memory 42 of the controlling device 40 monitors as to whether a predetermined period of time lapses until reaching 50° C. due to any cause (for example, malfunction of the halogen heater 67), and in the case where the predetermined period of time lapses, the apparatus power source is turned off (steps S4 and S5).

The timer A is counted up until the temperature reaches 70° C., and upon reaching 70° C., the timer A is terminated to count up. The count number of the timer A is stored in the memory 42 (steps S6 and S7). Thereafter, when the temperature reaches 80° C., a timer B is started to count up, and upon reaching 100° C., the timer B is terminated to count up. The count number of the timer B is stored in the memory 42 (steps S8 to S11).

The count numbers of the timers A and B thus calculated are compared in the determination section 43, and in the case where the value (B-A) is larger than the reference value, it is determined as abnormal temperature increase due to the paper winding around the heating roll 61, and the application of electricity on the halogen heater 67 is terminated, i.e., the power is turned off (steps S12 and S13). The reference value may be obtained in advance, for example, by a verification experiment with an apparatus of the same type.

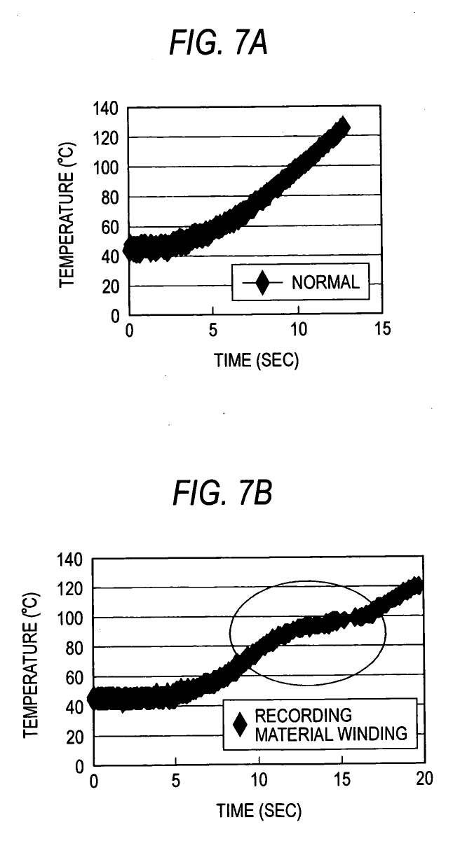

The abnormal temperature increase will be described with reference to temperature profiles. FIG. 7A is a graph showing an example of a normal temperature profile, and FIG. 7B is a graph showing an example of a temperature profile with paper winding.

In the case where the paper does not wind around the heating roll 61 of the fixing device 60, the surface temperature of the heating roll 61 is gradually increased in an S-curve form and finally controlled with the preset value as the fixing temperature, provided that FIG. 7A shows only the temperature profile until it is increased until about 120° C.

In the case where the paper winds around the heating roll 61, on the other hand, the surface temperature of the heating roll 61 is measured through the paper winding around it. Accordingly, the temperature is increased somewhat slowly in the initial stage due to the influence of the thermal conductivity of the paper, and then started to increase in the similar curve as in the normal state. However, the heating energy applied to the heating roll 61 is started to be consumed by evaporation of water contained in the paper winding around the heating roll 61, and thus the temperature increase is deferred (the temperature-rising time is prolonged) as shown by the part surrounded by the thin line circle in FIG. 7B. Thereafter, when water contained in the paper has evaporated to certain extent, the temperature is again increased in the similar manner as in the normal state.

In the embodiment, as shown in FIG. 7B, the temperature increase in a range of 80° C. to 100° C. is considerably deferred in comparison to the temperature increase in a range of 50° C. to 70° C., and therefore, the occurrence of the paper winding can be easily determined by comparing the count numbers in these temperature ranges, i.e., by comparing the count number of the timer B in a range of 80° C. to 100° C. and the count number of the timer A in a range of 50° C. to 70° C.

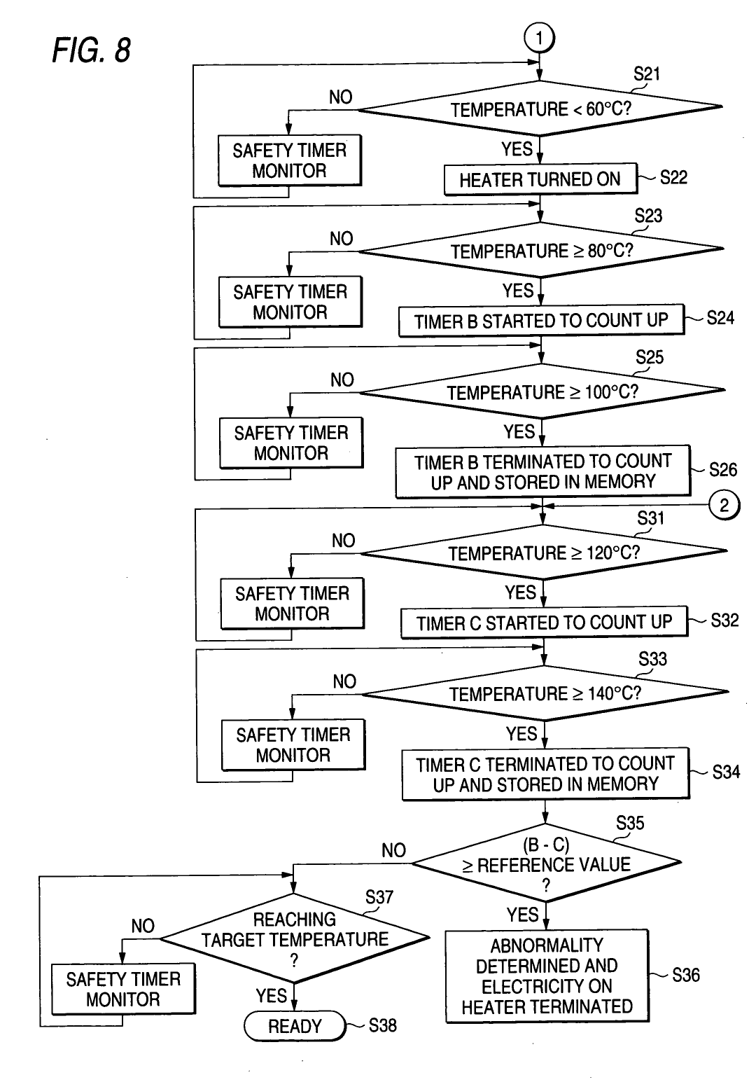

The temperature controlling process will be described with reference to FIG. 8. In the case where the value (B-A) is less than the reference value in the step S11 in FIG. 6, i.e., it is determined that the paper does not wind around the heating roll 61, the temperature is continuously increased, and a count number in a range of 120° C. to 140° C. is calculated by a timer C and stored (steps S31 to S34). The count numbers of the timer C and the timer B are compared, and in the case where the value (B-C) is larger than a reference value, it is determined as abnormal temperature increase due to the paper winding around the heating roll 61, and the application of electricity on the halogen heater 67 is terminated, i.e., the power is turned off (steps S36 and S36). The reference value herein may also be obtained in advance, for example, by a verification experiment with the same apparatus.

In the case where the value (B-C) does not reach the reference value, it is determined that the paper does not wind, and the temperature is increased until reaching the target temperature (preset fixing temperature) to complete preparation (ready) after reaching the target (steps S37 and S38).

Accordingly, the abnormal temperature increase due to the paper winding can be determined by comparing the count numbers the timers B and C, i.e., by comparing the temperature-rising time in a range of 80° C. to 100° C. and the temperature-rising time in a range of 120° C. to 140° C.

In the case where the temperature is not decreased to less than 30° C. in the step S2 in FIG. 6, for example, in the case where the period of time from resolution of paper jam to rebooting is short, it is determined as to whether or not the temperature is less than 60° C. as shown in step S21 in FIG. 8. In the case where the temperature is less than 60° C., the heater is turned on, and the temperature-rising time from 80 to 100° C. is counted with the timer B and stored (steps S22 to S26). Thereafter, the timer C for the temperature range of 120° C. to 140° C. is counted up, and the count numbers of the timer B and the timer C are compared (the steps for which are the same as steps S31 to S38 having been described, and descriptions thereof are omitted herein).

In this case, abnormal temperature increase due to the paper winding is determined only by the count numbers of the timer B and the timer C.

In the case where the temperature exceeds 60° C. in step S21 in the embodiment, the apparatus power source is turned off after lapsing the predetermined period of time under monitoring with the safety timer.

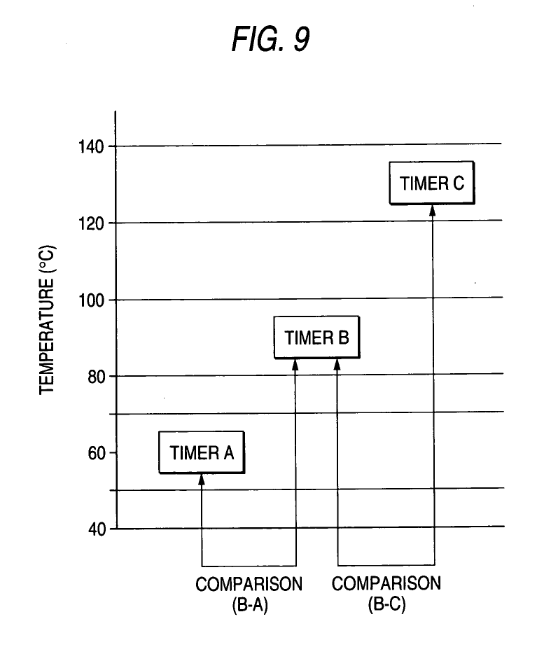

In the embodiment, as shown in FIG. 9, the timers A, B and C are provided, and the count numbers of the timers A and C are compared with the count number of the timer B, whereby it is determined as to whether or not the paper winds around the heating roll 61 of the fixing device 60. That is, the embodiment utilized the fact that the temperature-rising time measured with the timer B is increased due to evaporation of water in the paper to increase the count number of the timer B. In the case where the temperature on rebooting is low, both the count numbers of the timer A and the timer C can be compared with the count number of the timer B, whereby the determination of the paper winding can be made further safely.

In the fixing device 60 of the embodiment, as shown in FIG. 4, the thermostat 69 is provided to prevent the heating roll 61 from suffering malfunction due to abnormal temperature increase. The present operation temperature of the thermostat 69 is higher than the preset fixing temperature.

In the embodiment as having been described, the temperature-rising time in a temperature range of 80° C. to 100° C. is compared with the temperature-rising time in a temperature range of 50° C. to 70° C. or the temperature-rising time in a temperature range of 120° C. to 140° C. However, for example, the temperature-rising time in a temperature range of 80° C. to 100° C. may be compared with a reference time having been determined in advance to determine the paper winding.

In the embodiment, all the timers A, B and C measure temperature-rising times of a temperature range of 20° C., but the invention is not limited thereto. For example, it is possible that one of the temperature range is set at a range of 10° C., and upon comparison, the temperature-rising time of a range of 10° C. is converted by calculation to that of the same temperature range as the other ranges. In the embodiment, the temperature range measured with the timer A is from 50° C. to 70° C., but the range may be any range lower than 80° C. as far as it can be measured under the normal operation state. Similarly, the temperature range measured with the timer C is from 120° C. to 140° C., but the range may be any range of 120° C. or more and lower than the fixing temperature. Moreover, the temperature range measured with the timer B is from 80° C. to 120° C., but the range may be any range in a range of from 80° C. to 120° C.

The configurations of the timers may be appropriately changed respectively corresponding to the kind of the paper, such as thin paper and heavy paper, whereby the paper winding can be detected more accurately with good adaptation to paper.

In the embodiment, only one temperature sensor 68 is used for controlling the temperature, but plural temperature sensors may be provided. In this case, the aforementioned observation of the temperature-rising information (corresponding to the temperature-rising time) is made in the respective temperature sensors, and in the case at least one of the sensors determines the paper winding, the electricity applied to the halogen heater 67 is terminated (i.e., the power supply is turned off). According to the configuration, influence of fluctuation of the parts constituting the apparatus on determination of the paper winding can be suppressed to make the determination of the paper winding further safely.

As having been described, in the exemplary embodiment, the paper winding around the heating roll 61 of the fixing device 60 occurring after paper jam is determined by utilizing the fact that the temperature increase in a temperature range of 80° C. to 120° C. is largely different from the temperature increase in the other temperature ranges due to evaporation of water in the paper winding, whereby abnormality due to winding of paper can be prevented from being overlooked even though there is lowering in power supply or fluctuation of the parts of the apparatus.

Furthermore, the temperature increase in a range of 80° C. to 120° C. is compared to the temperature increase in a range of 80° C. or less or a range of 120° C. or more, whereby abnormality in paper winding can be accurately detected even though there is lowering in power supply.

In the exemplary embodiment, a monochrome image forming apparatus is used as the image forming apparatus, but the image forming apparatus may be those of other systems, for example, a so-called tandem color image forming apparatus equipped with plural photoreceptor drums, or a so-called cyclic color image forming apparatus carrying out repeated image transfer to an intermediate transfer material with one photoreceptor drum and then transferring toner images accumulated on the intermediate transfer material to paper at once, and in this case, the aforementioned fixing device may be used as the fixing devices of these image forming apparatus.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device for fixing a toner image on a recording medium, comprising:
a fixing member having a heat source;
a sensor which senses a surface temperature of the fixing member;
an abnormality determining section which obtains at least one of temperature-rising time information in a predetermined temperature range, temperature-rising time information in a temperature range lower than the predetermined temperature range, and temperature-rising time information in a temperature range higher than the predetermined temperature range, based on a result of sensing by the sensor, to determine whether or not an abnormality exists in the fixing member based on the obtained information; and
a heat controlling section which controls a power supply to the heat source, and lowers an amount of the power supply in operation when the abnormality determining section determines that an abnormality exists.

2. The fixing device according to claim 1,
wherein the abnormality determining section compares the temperature-rising time information in the predetermined temperature range with a reference temperature-rising time information which is any one of the temperature-rising time information in the temperature range lower than the predetermined temperature range and the temperature-rising time information in the temperature range higher than the predetermined temperature range, to determine whether or not an abnormality exists in the fixing member.

3. The fixing device according to claim 1,
wherein the predetermined temperature range is a temperature range in which water in the recording medium evaporates.

4. The fixing device according to claim 1,
wherein the predetermined temperature range is at least a part of a temperature range of 80° C. to 120° C. inclusive.

5. The fixing device according to claim 1,
wherein the predetermined temperature range is a temperature range of 80° C. to 100° C. inclusive.

6. The fixing device according to claim 1,
wherein the temperature range lower than the predetermined temperature range is a temperature range lower than 80° C., and the temperature range higher than the predetermined temperature range is a temperature range higher than 120° C.

7. The fixing device according to claim 2,
wherein the abnormality determining section determines an abnormality exists in the fixing member when the temperature-rising time information in the predetermined range shows a longer period of time than the reference temperature-rising time information.

8. The fixing device according to claim 2,
wherein the abnormality determining section uses any one of the temperature-rising time information in the temperature range lower than the predetermined temperature range and the temperature-rising time information in the temperature range higher than the predetermined temperature range by switching as the reference temperature increasing time information.

9. A fixing device for fixing a toner image on a recording medium, comprising:
a fixing member having a heat source;
a sensor which senses a surface temperature of the fixing member;
an abnormality determining section which obtains temperature-rising time information in a predetermined temperature range to determine whether or not an abnormality exists in the fixing member based on the obtained information; and
a heat controlling section which controls a power supply to the heat source, and lowers an amount of the power supply in operation when the abnormality determining section determines that an abnormality exists.

10. An image forming apparatus, comprising:
an image forming section which forms a toner image on a recording medium; and
a fixing device which fixes the toner image on the recording medium,
wherein the fixing device includes:
a fixing member having a heat source;
a sensor which senses a surface temperature of the fixing member;
an abnormality determining section which obtains at least one of temperature-rising time information in a predetermined temperature range, temperature-rising time information in a temperature range lower than the predetermined temperature range, and temperature-rising time information in a temperature range higher than the predetermined temperature range, based on a result of sensing by the sensor, to determine whether or not an abnormality exists in the fixing member based on the obtained information; and
a heat controlling section which controls a power supply to the heat source, and lowers an amount of the power supply in operation when the abnormality determining section determines that an abnormality exists.
